(19) United States
(12) Patent Application Publication
(10) Pub. No.: US 2026/0331905 A1
(43) Pub. Date: Oct. 22, 2026

(54) PROTECTION CIRCUIT CONTROLLER

(71) Applicant: TEXAS INSTRUMENTS INCORPORATED, Dallas, TX (US)

(72) Inventors: Durga Praveen GORRELA, Bengaluru (IN); Koshal SHARMA, Bengaluru (IN); Prateek PANDEY, Bengaluru (IN)

(21) Appl. No.: 19/464,518

(22) Filed: Jan. 29, 2026

(30) Foreign Application Priority Data
Apr. 17, 2025 (IN) 202541037093

(51) Int. Cl. H02H 7/18; H02H 1/00; H02H 1/04

(52) U.S. Cl. CPC H02H 7/18; H02H 1/0007; H02H 1/0038; H02H 1/0061; H02H 1/04

(57) ABSTRACT

An apparatus includes a controller having: a switch control output; a first terminal; and a second terminal. The controller includes: a switch coupled between the first and second terminals; and control circuitry having outputs coupled to the switch control output and a control input of the switch. In a first mode, the control circuitry is configurable to set the switch control output to a first state and disable the switch. In a second mode, the control circuitry is configurable to: set the switch control output to a second state and enable the switch; and responsive to a transient signal at the first terminal or the second terminal, enter a third mode by setting the switch control output to the first state and disabling the switch for an interval, and then transitioning back to the second mode after the interval elapses.

### CROSS-REFERENCE TO RELATED APPLICATIONS

This application claims priority to India Provisional Application No. 202541037093, filed Apr. 17, 2025, titled “Supporting Automotive Transients and High Load Current (>1 A) Transients During SLEEP Mode in Ideal Diode Devices,” which is hereby incorporated by reference by its entirety.

### BACKGROUND

Various electronic devices may include a protection circuit to protect electronic components from a high-voltage and/or high-current condition. An example protection circuit includes a switch and a controller, where the controller turns on the switch in a steady-state (on) condition and turns off the switch responsive to a high-voltage or high-current condition. Some protection circuits support a low quiescent current (Iq) sleep mode with limited current available to downstream electronics. Efforts to improve control options of a protection circuit are ongoing.

### SUMMARY

In an example, an apparatus includes a controller having: a switch control output; a first terminal; and a second terminal. The controller includes: a switch coupled between the first and second terminals; and control circuitry having outputs coupled to the switch control output and a control input of the switch. In a first mode, the control circuitry is configurable to set the switch control output to a first state and disable the switch. In a second mode, the control circuitry is configurable to: set the switch control output to a second state and enable the switch; and responsive to a transient signal at the first terminal or the second terminal, enter a third mode by setting the switch control output to the first state and disabling the switch for an interval, and then transitioning back to the second mode after the interval elapses.

In another example, a method includes a first mode, a second mode, and a third mode. In the first mode, the method includes: disabling a first switch and enabling a second switch to provide a first current path between first and second terminals; and setting a first overcurrent threshold. In the second mode, the method includes: enabling the first switch and disabling the second switch to provide a second current path between the first and second terminals; setting a second overcurrent threshold lower than the first overcurrent threshold; and responsive to a transient signal at the first terminal or the second terminal, entering the third mode by enabling the second switch and disabling the first switch for an interval, and then transitioning back to the second mode after the interval elapses

In another example, a system includes: a battery terminal; a power terminal; a switch interface between the battery terminal and the power terminal, the switch interface having a control input; and a controller having a switch control output, a first terminal, and a second terminal. The switch control output is coupled to the control input of the switch interface. The controller includes a switch coupled between the first and second terminals and is configurable to: set the switch control output to a first state and enable the switch; and responsive to a transient signal at the first terminal or the second terminal, set the switch control output to a second state and disable the switch.

### BRIEF DESCRIPTION OF THE DRAWINGS

FIG. 1A is a schematic illustrating a block diagram of a system including a protection circuit with a switch interface and a controller, according to various examples.

FIG. 1B is a schematic illustrating a diagram of a system including a protection circuit with a switch interface and a controller, according to various examples.

FIGS. 2A to 2C are graphs illustrating transient events, according to various examples.

FIG. 3 is a schematic illustrating a diagram of a protection circuit controller, according to various examples.

FIG. 4A is a flowchart illustrating a protection circuit controller method, according to various examples.

FIG. 4B is a state diagram illustrating a state machine with modes of a protection circuit controller, according to various examples.

FIGS. 5 to 7 are timing diagrams showing protection circuit signals responsive to different transient events, according to various examples.

### DETAILED DESCRIPTION

The same reference numbers or other reference designators are used in the drawings to designate the same or similar (either by function and/or structure) features.

Described herein is a protection circuit with a switch interface and a controller. The protection circuit may be used, for example, between a power source and a load to control current flow to the load and/or prevent reverse current flow to the power source. The switch interface includes one or more switches. In some examples, the controller includes logic/drivers and a sleep mode switch (e.g., SLEEP_FET herein). In some examples, the controller uses the logic/drivers to support steady-state mode operations, sleep mode operations, transient high-current mode operations, latch off sleep mode operations, and switching between these different mode. During steady-state mode operations (e.g., when a vehicle or other system is on), the controller turns on any switches of the switch interface and turns off the sleep mode switch, resulting in a steady-state mode current being provided from the power source to the load via the switch interface. During sleep mode (or low power mode) operations (e.g., when a vehicle or other system is off or in a low-power state), the controller turns off all switches of the switch interface and turns on the sleep mode switch, resulting in a sleep mode current being provided from the power source to the load via the sleep mode switch. The steady-state mode current is greater than the sleep mode current. In one example, the steady-state mode current may be up to 21 A, and the sleep mode current may be up to 150 mA.

During the sleep mode (or the low power mode), a transient event may occur. Example transient events include a load dump, a jump start, and a transient load. In some examples, during a load dump event, the load may be abruptly disconnected from the protection circuit, resulting in a voltage spike. An example load dump event may cause an abrupt voltage spike (e.g., a 1 ms transition from 13.5V to 35V), a high-voltage interval (e.g., at 35V), and a slow voltage drop (e.g., dropping from 35V back to 13.5V) after the high-voltage interval. In some examples, during a jump start event, a high voltage may be applied across terminals of the power source (e.g., a battery) for a jump start interval. An example jump start includes: an abrupt voltage spike (e.g., a transition from 10.8V to 26V), a jump start interval (e.g., maintaining 26V for 60 seconds), and an abrupt voltage drop (e.g., dropping from 26V back to 10.8V) after the jump start interval. In some examples, in a transient load event, the load may have one or more load current pulses greater than a threshold. An example transient load includes multiple load current pulses, each load current pulse having a target amplitude (e.g., 1A-2A) and duration (e.g., 750 ms).

Occurrence of a load dump, a jump start, a transient load, or another transient event during the sleep mode results in an overcurrent condition for the sleep mode switch. The sleep mode switch may be disabled in response to the detection of the overcurrent condition to protect the sleep mode switch, but the disabling may lead to the load (e.g., a keyless entry system of a vehicle) not receiving power from the power source and not operational during the sleep mode. The limited safe operation area (SOA) of the sleep mode switch also makes it difficult to implement device start up into sleep mode with inrush current limit, and the sleep mode switch may be unable to support the high currents of the transient loads.

Examples described herein can address at least some of the problems described above, by temporarily turning on at least one switch of the switch interfaces during a sleep mode responsive to detection of such an overcurrent event for the sleep mode switch. In some examples, the protection circuit may include a first overcurrent detection circuit (e.g., the overcurrent detection circuit 109 herein) for the switch interface and a second overcurrent detection circuit (e.g., the overcurrent detection circuit 310 herein) for the sleep mode switch. In some examples, the first overcurrent detection circuit is external to the controller while the second overcurrent detection circuit is part of the controller. In other examples, the first and second overcurrent detection circuits may be part of the controller. The first overcurrent detection circuit operates to: detect a first overcurrent condition for one or more switches of the switch interface; and generate a first overcurrent fault signal (FLT herein) responsive to the first overcurrent condition. The second overcurrent detection circuit operates to: detect a second overcurrent condition for the sleep mode switch; and generate a second overcurrent fault signal responsive to the second overcurrent condition. With the first and second overcurrent detection circuits, the second overcurrent fault signal is triggered by a lower current (e.g., 150 mA for 3.5 us) compared to the first overcurrent fault signal (e.g., triggered by 20 A for 2.2 us).

In some examples, in response to detecting a transient event during a sleep mode (e.g., using the second overcurrent detection circuit and/or indicated by the second overcurrent fault signal), the controller performs transient high-current state operations. In some examples, a current of 150 mA or more through the sleep mode switch triggers the second overcurrent fault signal. In some examples, the transient high-current state operations include: turning off the sleep mode switch; and turning on at least one switch of the switch interface for a transient interval. During the transient interval, current is provided from the power source to the load via the switch interface. After the transient interval, the controller returns to the sleep mode, in which switches of the switch interface are turned off and the sleep mode switch is turned on. In some examples, the controller is able to adjust the duration of the transient interval. If a transient event duration is greater than the transient interval, the controller may repeat the process of: detecting the transient event (e.g., using the second overcurrent detection circuit); turning off the sleep mode switch responsive to the detected transient event; and turning on at least one switch of the switch interface for a transient interval. During the transient high-current state, if a first overcurrent condition is detected (e.g., using the first overcurrent detection circuit), the controller transitions to the latch off sleep mode. During the latch off sleep mode, the controller operates to: turn off all switches of the switch interface; and turn off the sleep mode switch. From the latch off sleep mode, the controller may transition to the steady-state mode once the first overcurrent fault condition (e.g., FLT herein) has cleared, the power source is available or cycled, and a sleep mode control signal (e.g., SLEEP herein) has a first state (e.g., a low or “0” state). In some examples, an enable signal (EN herein) may be used to control when the protection circuit is enabled or disabled.

With such arrangements, the protection circuit can provide robust overcurrent protection for the load while allowing the switch interface to temporarily conduct a current that exceeds the current limit of the sleep mode switch (e.g., 150 mA) to the load during the sleep mode during the transient events, as long as such a current does not trigger the first overcurrent fault signal (e.g., being 20 A or less). Such arrangements can ensure that the load can receive power during the sleep mode even with the transient events, which in turn can ensure that critical features (e.g., vehicle entry system, safe state cameras, etc.) can remain operational, without the need for additional circuitry to bypass the sleep mode switch and transmit power from the power source to the load in such transient events.

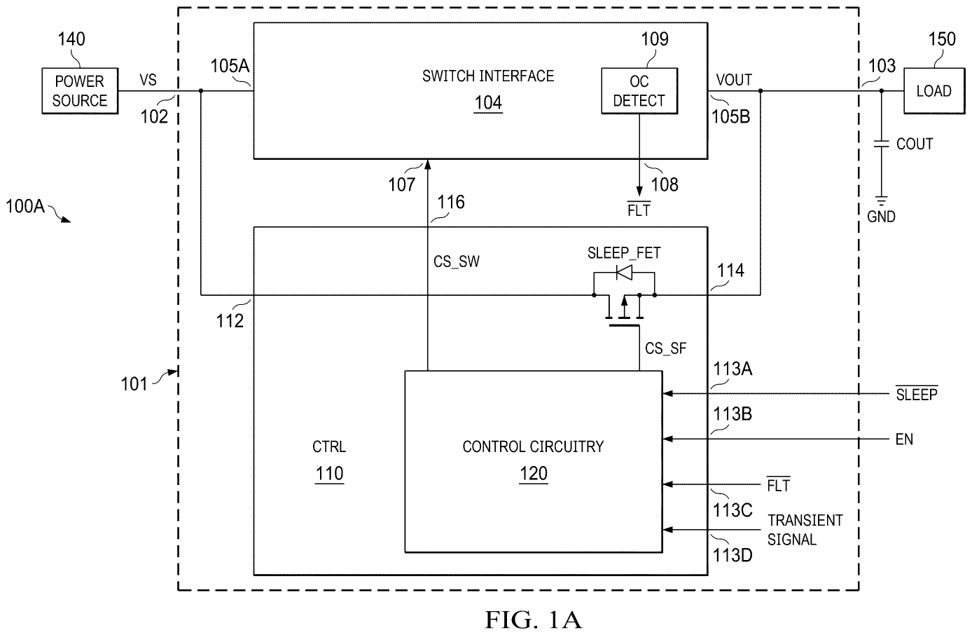

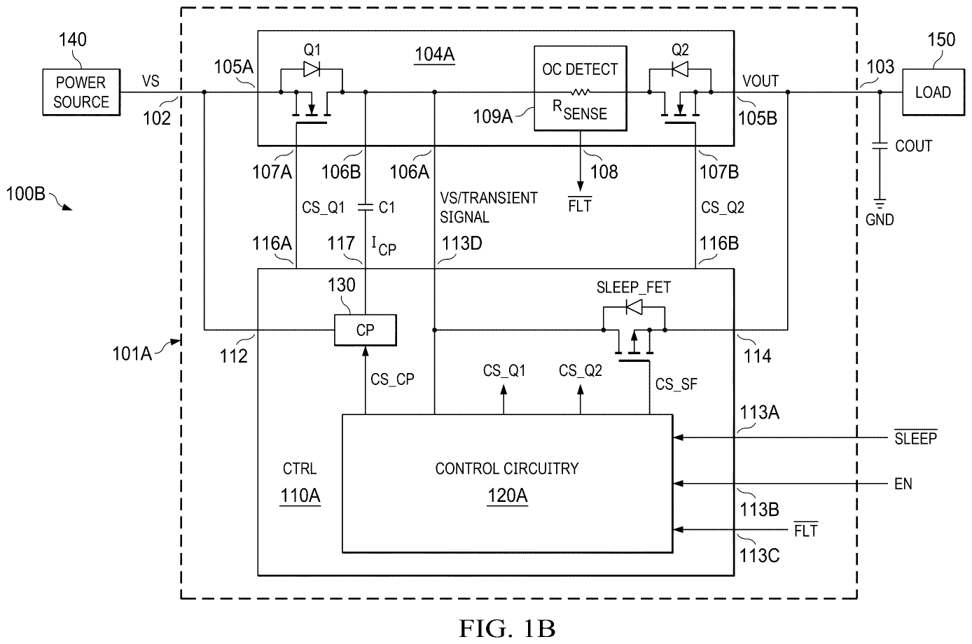

FIG. 1A is a schematic illustrating a block diagram of a system 100A including a protection circuit 101 with a switch interface 104 and a controller 110, according to various examples. The system 100A includes a power source 140, the protection circuit 101, a capacitor COUT, and a load 150 in the arrangement shown. The protection circuit 101 has a first terminal 102 and a second terminal 103. In some examples, the power source 140 is a battery and the first terminal 102 of the protection circuit 101 may be referred to as a battery terminal of the protection circuit 101. The second terminal 103 of the protection circuit 101 is coupled to the load 150 and may be referred to as a power terminal of the protection circuit 101. Switch interface 104 and controller 110 can be part of a packaged integrated circuit (IC) or can be in different packaged ICs.

In some examples, the system 100A can be part of a vehicle with an on-state and a low-power state (e.g., off or low quiescent current state). In other examples, the system 100A may be part of an electronic device (e.g., a computer) with an on-state and a low-power state. In different examples, the power source 140 may be a battery or a power converter. The load 150 may include vehicle electronics, computer electronics, or other system electronics. Example loads include a cockpit control unit, a radio frequency (RF) load such as remote keyless entry (RKE), passive start and entry (PASE), a camera electronic control unit (ECU), or other loads. In some examples, the controller 110 is a controller integrated circuit (IC) and the switch interface 104 and capacitor COUT are external to the controller IC.

In the example of FIG. 1A, the switch interface 104 has a first terminal 105A, a second terminal 105B, control input(s) 107, and a fault output 108. The switch interface 104 includes one or more switches (not shown) and an overcurrent detection circuit 109 coupled to the fault output 108. The overcurrent detection circuit 109 provides the fault signal FLT to indicate whether or not the switch interface 104 has a fault condition (e.g., the first overcurrent condition herein).

As shown, the controller 110 has a first terminal 112, a second terminal 114, a first input 113A, a second input 113B, a third input 113C, a fourth input 113D, and switch control output(s) 116. As shown, the controller 110 includes control circuitry 120 and a transistor labelled SLEEP_FET, which is configurable as a sleep mode switch. In the example of FIG. 1A, the transistor SLEEP_FET is a p-channel field-effect transistor (PFET) with a first current terminal (e.g., a source terminal), a second current terminal (e.g., a drain terminal), and a control input (e.g., a gate terminal).

In the example of FIG. 1A, the first terminal 105A of the switch interface 104 and the first terminal 112 of the controller 110 are coupled to the first terminal 102 of the protection circuit 101. The second terminal 105B of the switch interface 104 and the second terminal 114 of the controller 110 are coupled to the second terminal 103 of the protection circuit 101. The control input(s) 107 of the switch interface 104 is coupled to the switch control output(s) 116 of the controller 110. The fault output 108 of the switch interface 104 is coupled to the third input 113C of the controller 110. The first current terminal of the transistor SLEEP_FET is coupled to the second terminal 114 of the controller 110. The second current terminal of the transistor SLEEP_FET is coupled to the first terminal 112 of the controller 110.

In the example of FIG. 1A, the controller 110 (e.g., using the logic/drivers 120) supports steady-state mode operations, sleep mode operations, transient high-current mode operations, latch off sleep mode operations, and switching between the different modes. In some examples, the different modes of the controller 110 are triggered by: the state of a sleep signal S̅L̅E̅E̅P̅ at the first input 113A of the controller 110; the state of an enable signal EN at the second input 113B of the controller 110; the state of a fault signal F̅L̅T̅ at the third input 113C of the controller 110; the state of a transient signal at the fourth input 113D of the controller 110; and operations of the control circuitry 120. In different scenarios, the control circuitry 120 operates to: receive the transient signal and first or second states for S̅L̅E̅E̅P̅, EN, F̅L̅T̅; select a mode responsive to the transient signal and the states of S̅L̅E̅E̅P̅, EN, F̅L̅T̅; control the state of switch control signal(s) CS_SW at the switch control output(s) 116 responsive to the selected mode; and control the state of switch control signal CS_SF for the transistor SLEEP_FET responsive to the selected mode.

During steady-state mode operations (e.g., when the system 100A is on), switch interface 104 receives a supply voltage (VS) from the power source 140 at the first terminal 105A, and provide an output voltage (VOUT) to the load 150 that tracks VS at the second terminal 105B. Switch interface 104 also allows current to flow from the first terminal 105A to the second terminal 105B, and block a reverse current flow from the second terminal 105B to the first terminal 105A (from the load 150 to the power source 140). More specifically, during steady-stage operations, the controller 110 (e.g., using control circuitry 120) operates to: control the state of switch control signal(s) CS_SW at the switch control output(s) 116 to turn on any switches of the switch interface 104; and control the state of switch control signal CS_SF using the control circuitry 120 to turn off the transistor SLEEP_FET. In some examples, a first state of the switch control signal(s) CS_SW is a low or off state, and a second state of the switch control signal(s) CS_SW is a high or on state. During the steady-state mode, a steady-state current is provided from the power source 140 to the load 150 via the switch interface 104. In some examples, the controller 110 (e.g., using control circuitry 120) initiates the steady-state mode responsive to SLEEP having a first state (e.g., a high or “1” state) indicating no sleep request, EN having a first state (e.g., a high or “1” state) indicating the protection circuit is enabled, and FLT having a first state (e.g., a high or “1” state) indicating there is no fault condition for the switch interface 104.

During sleep mode operations (e.g., when the system 100A is off or in a low-power state), the controller 110 (e.g., using control circuitry 120) operates to: control the state of the switch control signal(s) CS_SW at the switch control output(s) 116 to turn off any switches of the switch interface 104; and control the state of the switch control signal CS_SF to turn on the transistor SLEEP_FET. During the sleep mode, a sleep mode current is provided from the power source 140 to the load 150 via the transistor SLEEP_FET. The steady-state current is greater than the sleep mode current. In one example, the steady-state mode current may be up to tens of amps and the sleep mode current may be up to 150 mA. In some examples, the controller 110 (e.g., using control circuitry 120) transitions from the steady-state mode to the sleep mode responsive to SLEEP having a second state (e.g., a low or “0” state) indicating a sleep request, EN having the first state (e.g., a high or “1” state) indicating the protection circuit is enabled, and FLT having the first state (e.g., a high or “1” state) indicating there is no fault condition for the switch interface 104.

During the sleep mode, a transient event related to the transient signal may occur. Example transient events include a load dump, a jump start, and a transient load. In some examples, the control circuitry 120 includes an overcurrent detection circuit (e.g., the second overcurrent detection circuit such as the overcurrent detection circuit 310 herein) to detect such transient events as a second overcurrent condition related to the transistor SLEEP_FET. In some examples, the controller 110 detects a transient event by detecting an overcurrent condition for the transistor SLEEP_FET due to the state of the transient signal at the fourth input 113D of the controller 110. Responsive to detecting a transient event and/or the overcurrent condition for the transistor SLEEP_FET, the controller 110 initiates transient high-current mode operations. Example transient high-current mode operations include: turning off the transistor SLEEP_FET; and controlling the state of the switch control signal(s) CS_SW at the switch control output(s) 116 to turn on at least one switch of the switch interface 104 for a transient interval, and then turn off the at least one switch after the interval elapses. During the transient interval, current is provided from the power source 140 to the load 150 via the switch interface 104 for the transient event as part of the transient high-current mode operation. For example, inrush current can flow to charge the capacitor COUT, to supply the transient load, etc. In some examples, transient high-current mode operations of the controller 110 may include the disabling any sleep mode functions (e.g., use of the sleep mode switch, monitoring for an overcurrent condition of the sleep mode switch, etc.)

After the transient interval elapses and the transient high-current mode operation ends, the controller 110 (e.g., using control circuitry 120) returns to the sleep mode and operates to: control the state of the switch control signal(s) CS_SW at the switch control output(s) 116 to turn off the at least one switch of the switch interface 104 that was turned on during the transient high-current mode operation; and control the state of the switch control signal CS_SF to turn on the transistor SLEEP_FET. In some examples, the controller 110 is able to adjust the duration of the transient interval. For example, the control circuitry 120 may include a programmable timer (e.g., timer 350 herein) to adjust the transient interval duration.

As needed, transient high-current mode operations may be repeated as long as F̅L̅T̅ has the first state (e.g., a high or “1” state) indicating there is no fault condition for the switch interface 104. If F̅L̅T̅ has a second state (e.g., a low or “0” state) indicating the switch interface 104 has a fault condition (e.g., the first overcurrent condition), the controller 110 (e.g., using the control circuitry 120) may transition from the transient high-current mode to the latch off sleep mode. In some examples, during the latch off sleep mode, the controller 110 operates to: control a state of the switch control signal(s) CS_SW at the switch control output(s) 116 to turn off any switches of the switch interface 104; and control a state of the switch control signal CS_SF to turn off the transistor SLEEP_FET. In the latch off sleep mode, the protection circuit 101 can prevent a current from flowing from the power source 140 to the load 150 due to F̅L̅T̅ indicating a fault condition for the switch interface 104.

In some examples, the controller 110 (e.g., using the control circuitry 120) may transition from the latch off sleep mode to the steady-state mode responsive to S̅L̅E̅E̅P̅ having the first state (e.g., a high or “1” state) indicating there is no sleep request. In other examples, the controller 110 (e.g., using the control circuitry 120) may transition from the latch off sleep mode to the sleep mode responsive to EN transitioning from the first state (e.g., a high or “1” state) to the second state (e.g., a low or “0” state”) and back to the first state. If an overcurrent condition occurs at the SLEEP_FET transistor during the sleep mode, the controller 110 can transition from the sleep mode to the transient high-current mode for a transient interval, in which a current can flow from the power source to, for example, charge the capacitor COUT, support a transient load, etc., and then returns to the sleep mode. In other examples, the controller 110 (e.g., using the control circuitry 120) may transition from the latch off sleep mode to the sleep mode responsive to VS transitioning from high to low and back to high. If an overcurrent condition occurs during the sleep mode, the controller 110 can transition from the sleep mode to the transient high-current mode for a transient interval (e.g., to charge COUT, to support a transient load, etc.) and then return to the sleep mode.

FIG. 1B is a schematic illustrating a diagram of a system 100B including a protection circuit 101A with a switch interface 104A and a controller 110A, according to various examples. The protection circuit 101A in FIG. 1B is an example of the protection circuit 101 in FIG. 1A. The switch interface 104A in FIG. 1B is an example of the switch interface 104 in FIG. 1A. The controller 110A in FIG. 1B is an example of the controller 110 in FIG. 1A. The system 100B includes the power source 140, the protection circuit 101A, the capacitor COUT, and the load 150 in the arrangement shown. The protection circuit 101A has the first terminal 102 and the second terminal 103 described in FIG. 1A.

In some examples, the system 100B is part of a vehicle. In other examples, the system 100B is part of an electronic device (e.g., a computer) with an on-state (e.g., a steady-state mode) and a low-power state (e.g., a sleep mode). In different examples, the power source 140 may be a battery or a power converter. The load 150 may include vehicle electronics, computer electronics, or other system electronics. Example loads include a cockpit control unit, an RF load such as RKE, PASE, a camera ECU, or other loads. In some examples, the controller 110A in FIG. 1B may be a controller IC and the switch interface 104A and capacitor COUT are external to the controller IC.

In the example of FIG. 1B, the switch interface 104A has the first terminal 105A, the second terminal 105B, a first control input 107A, a second control input 107B, a third terminal 106A, a fourth terminal 106B, and the fault output 108. The switch interface 104A includes transistors Q1 and Q2, and overcurrent detection circuit 109A in the arrangement shown. The overcurrent detection circuit 109A is an example of the overcurrent detection circuit 109 in FIG. 1A. In some examples, the overcurrent detection circuit 109A is part of the controller 110A. In the example of FIG. 1B, the overcurrent detection circuit 109A includes a sense resistor RSENSE and may include other overcurrent detection components. The controller 110A has the first terminal 112, the second terminal 114, a first switch control output 116A, a second switch control output 116B, a charge pump output 117, the first input 113A, the second input 113B, the third input 113C, and the fourth input 113D. The protection circuit 101 also includes capacitor C1, which is part of a charge pump to selectively turn on transistors Q1 and/or transistor Q2 of the switch interface 104A.

As shown, the controller 110A includes control circuitry 120A, the transistor SLEEP_FET (a sleep mode switch), and a charge pump (CP) circuit 130 in the arrangement shown. The control circuitry 120A in FIG. 1B is an example of the control circuitry 120 in FIG. 1A.

The first terminal 105A of the switch interface 104A and the first terminal 112 of the controller 110A are coupled to the first terminal 102 of the protection circuit 101A. The second terminal 105B of the switch interface 104A and the second terminal 114 of the controller 110A are coupled to the second terminal 103 of the protection circuit 101A. The first control input 107A of the switch interface 104A is coupled to the first switch control output 116A of the controller 110A. The second control input 107B of the switch interface 104A is coupled to the second switch control output 116B of the controller 110A. A first terminal of the capacitor C1 is coupled to the fourth terminal 106B of the switch interface 104A. A second terminal of the capacitor C1 is coupled to the charge pump output 117 of the controller 110A. The third terminal 106A of the switch interface 104A is coupled to the fourth input 113D of the controller 110A. The first current terminal of the transistor SLEEP_FET is coupled to the second terminal 114 of the controller 110A. The second current terminal of the transistor SLEEP_FET is coupled to the fourth input 113D of the controller 110A.

In the example of FIG. 1B, the transistors Q1 and Q2 are n-channel field-effect transistors (NFETs), each NFET having a respective first current terminal (e.g., a source terminal), a respective second current terminal (e.g., a drain terminal), and a respective control input (e.g., a gate terminal). The first current terminal of the transistor Q1 is coupled to the first terminal 105A of the switch interface 104A. The second current terminal of the transistor Q1 is coupled to the third terminal 106A of the switch interface 104A, the fourth terminal 106B of the switch interface 104A, and a first terminal of the resistor RSENSE. The control input of the transistor Q1 is coupled to the first control input 108A of the switch interface 104A. A second terminal of the resistor RSENSE is coupled to the second current terminal of the transistor Q2. The first current terminal of the transistor Q2 is coupled to the second terminal 105B of the switch interface 104A. The control input of the transistor Q2 is coupled to the second control input 107B of the switch interface 104A. The overcurrent detection circuit 109A is coupled to the fault output 108 of the switch interface 104A.

With the capacitor C1 coupled to the charge pump output 117 and VS, energy is selectively provided to turn on the transistors Q1 and Q2. In some examples, the charge pump circuit 130 operates to: receive VS; receive a charge pump control signal CP_CS; and selectively source a charge pump current I_{CP} (e.g., 2.7 mA) to the charge pump output 117 responsive to VS and CP_CS. When the charge pump control signal CP_CS has a first state (e.g., a high or “1” state), the charge pump circuit 130 is enabled and I_{CP} is used to charge the capacitor C1. When the charge pump control signal CP_CS has a second state (e.g., a low or “0” state), the charge pump circuit 130 is disabled and I_{CP} is not provided. The charge on the capacitor C1 may be used to drive the transistors Q1 and Q2. In some examples, to ensure that the transistors Q1 and Q2 can be driven above their threshold voltages, the charge on C1 is controlled to be greater than an undervoltage lockout threshold (e.g., 6.6V) before an internal gate driver (not shown) of the switch interface 104 is enabled.

In the example of FIG. 1B, the controller 110A (e.g., using control circuitry 120A) supports steady-state mode operations, sleep mode operations, transient high-current mode operations, latch off sleep mode operations, and switching between the different modes as described in FIG. 1A. Again, the different modes of the controller 110A may be triggered by: the state of the sleep signal S̅L̅E̅E̅P̅ at the first input 113A of the controller 110A; the state of the enable signal EN at the second input 113B of the controller 110A; the state of the fault signal F̅L̅T̅ at the third input 113C of the controller 110A; and the transient signal at the fourth input 113D of the controller 110A. In some examples, to reduce current consumption, the control circuitry 120A may control the state of charge pump control signal CP_CS to disable the charge pump circuit 130 in select modes (e.g., the sleep mode). For the steady-state mode and the transient high-current mode, the control circuitry 120A controls the state of CP_CS to enable the charge pump circuit 130 and thereby provide I_{CP} to the capacitor C1.

During steady-state mode operations (e.g., when the system 100B is on), VS from the power source 140 is provided as VOUT to the load 150 and reverse current flow (from the load 150 to the power source 140) is blocked. More specifically, during steady-stage operations, the controller 110A (e.g., using the control circuitry 120A) operates to: control the state of CS_Q1 at the first switch control output 116A to turn on the transistor Q1; control the state of CS_Q2 at the second switch control output 116B to turn on the transistor Q2; enable the charge pump circuit 130 to provide I_{CP} at the charge pump output 117 (to charge the capacitor C1 and power drive signals or a separate driver for the transistors Q1 and Q2); and control the state of CS_SF to turn off the transistor SLEEP_FET. In some examples, a first state of CS_Q1 and CS_Q2 is a low or off state, and a second state of CS_Q1 and CS_Q2 is a high or on state. During the steady-state mode, a steady-state current is provided from the power source 140 to the load 150 via the switch interface 104A. In some examples, the controller 110A initiates the steady-state mode responsive to SLEEP having the first state (e.g., a high or “1” state) indicating no sleep request, EN having the first state (e.g., a high or “1” state) indicating the protection circuit is enabled, and FLT having the first state (e.g., a high or “1” state) indicating there is no fault condition for the switch interface 104A.

During sleep mode operations (e.g., when the system 100B is off or in a low-power state), the controller 110A (e.g., using the control circuitry 120A) operates to: control the state of CS_Q1 at the first switch control output 116A to turn off the transistor Q1; control the state of CS_Q2 at the second switch control output 116B to turn off the transistor Q2; disable the charge pump circuit 130 to reduce power consumption; and control the state of CS_SF to turn on the transistor SLEEP_FET. During the sleep mode, a sleep mode current is provided from the power source 140 to the load 150 via the transistor SLEEP_FET. Again, the steady-state current is greater than the sleep mode current. In one example, the steady-state mode current may be up to tens of amps and the sleep mode current may be up to 150 mA. In some examples, the controller 110A (e.g., using the control circuitry 120A) transitions from the steady-state mode to the sleep mode responsive to S̅L̅E̅E̅P̅ having a second state (e.g., a low or “0” state) indicating a sleep request, EN having the first state (e.g., a high or “1” state) indicating the protection circuit is enabled, and FLT having the first state (e.g., a high or “1” state) indicating there is no fault condition for the switch interface 104A.

During the sleep mode, a transient event may occur. Example transient events include a load dump, a jump start, and a transient load. In some examples, the control circuitry 120A includes an overcurrent detection circuit (e.g., the second overcurrent detection circuit herein such as the overcurrent detection circuit 310) to detect such transient events as a second overcurrent condition (separate from FLT) related to the transistor SLEEP_FET. In some examples, the controller 110A detects a transient event by detecting an overcurrent condition for the transistor SLEEP_FET due to the state of the transient signal at the fourth input 113D of the controller 110A. Responsive to detecting a transient event, the controller 110A (e.g., using the control circuitry 120A) initiates transient high-current mode operations. Example transient high-current mode operations include: controlling the state of CS_SF to turn off the transistor SLEEP_FET; controlling the state of CS_Q2 to turn on the transistor Q2; controlling a state of CS_CP to enable the charge pump circuit 130 to provide I_{CP} at the charge pump output 117 for the transient interval (to charge the capacitor C1 and power the drive signal for transistor Q2 or a separate driver for the transistor Q2); and control the state of CS_SF to turn off the transistor SLEEP_FET.

During the transient interval, current is provided from the power source 140 to the load 150 via the switch interface 104A. In some examples, transient high-current mode operations of the controller 110A may include disabling sleep mode operations in which, for example, the sleep mode switch is disabled, and the overcurrent detection for the sleep mode switch may also be disabled.

After the transient interval, the controller 110A (e.g. using the control circuitry 120A) returns to the sleep mode and operates to: control the state of CS_Q1 and CS_Q2 to turn off the transistor Q1 and Q2; control the state of CS_CP to disable the charge pump circuit 130; and control the state of the switch control signal CS_SF to turn on the transistor SLEEP_FET. In some examples, the controller 110A is able to adjust the duration of the transient interval. For example, the control circuitry 120A may include a programmable timer (e.g., timer 350 herein) to adjust the transient interval duration.

In some examples, transient high-current mode operations may be repeated as long as F̅L̅T̅ has the first state (e.g., a high or “1” state) indicating there is no fault condition for the switch interface 104A and the sleep mode current is higher than the overcurrent detection threshold for the sleep mode switch. If F̅L̅T̅ has a second state (e.g., a low or “0” state) indicating the switch interface 104A has a fault condition (e.g., the first overcurrent condition), the controller 110A (e.g., using the control circuitry 120A) may transition from the transient high-current mode to the latch off sleep mode to disconnect the load 150 from the power source 140. In some examples, during the latch off sleep mode, the controller 110A operates to: control a state of CS_Q1 and CS_Q2 to turn off the transistors Q1 and Q2; control a state of CS_CP to disable the charge pump circuit 130; and control a state of the switch control signal CS_SF to turn off the transistor SLEEP_FET. In the latch off sleep mode, the protection circuit 101A does not allow current to flow from the power source 140 to the load 150 due to F̅L̅T̅ indicating a fault condition for the switch interface 104A.

In some examples, the controller 110A (e.g., using the control circuitry 120A) may transition from the latch off sleep mode to the steady-state mode responsive to SLEEP having the first state (e.g., a high or “1” state) indicating there is no sleep request. In other examples, the controller 110A (e.g., using the control circuitry 120A) may transition from the latch off sleep mode to the sleep mode responsive to EN transitioning from the first state (e.g., a high or “1” state) to the second state (e.g., a low or “0” state”) and back to the first state. If an overcurrent condition occurs during the sleep mode, the controller 110A can transition from the sleep mode to the transient high-current mode for a transient interval (charging the capacitor COUT) and then return to the sleep mode. In other examples, the controller 110A (e.g., using the control circuitry 120A) may transition from the latch off sleep mode to the sleep mode responsive to VS transitioning from high to low and back to high. If an overcurrent condition occurs during the sleep mode, the controller 110A can transition from the sleep mode to the transient high-current mode for a transient interval (e.g., to charge the capacitor COUT, to support the transient load, etc.) and then return to the sleep mode.

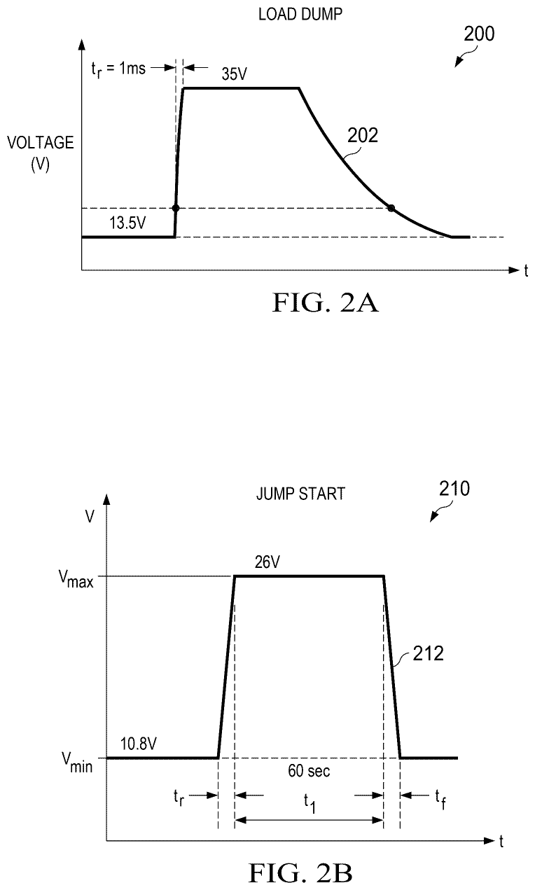

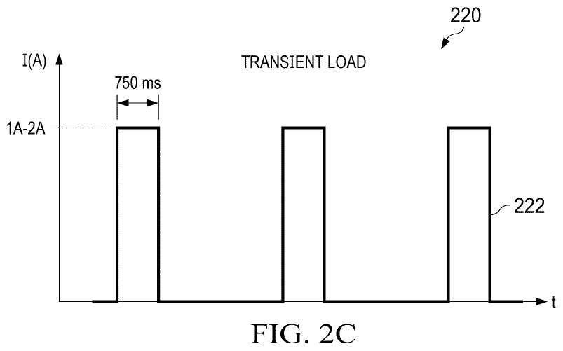

FIGS. 2A to 2C are graphs 200, 210, and 220 illustrating respective transient events 202, 212, and 222, according to various examples. In the example of FIG. 2A, the transient event 202 of graph 200 is a load dump. During a load dump, a system load is abruptly disconnected resulting in a voltage spike. An example load dump may occur during the sleep mode (when the vehicle's engine is off and electronic systems are powered by the battery). For example, when the engine is turned on, a load dump may occur during a delay in the transition of electronic circuits from sleep mode to normal mode (steady-state mode). Another example load dump may occur if a vehicle's battery is disconnected (e.g., from an alternator) while being charged. In FIG. 2A, the transient event 202 includes: an abrupt voltage spike (e.g., a 1 ms transition from 13.5V to 35V), a high voltage interval (e.g., at 35V), and a slow voltage drop (e.g., dropping from 35V back to 13.5V).

In the example of FIG. 2B, the transient event 212 of graph 210 is a jump start. During a jump start, a high voltage is applied across a battery terminal for a jump start interval. An example jump start may be performed if the voltage of a vehicle's battery is below a threshold. In FIG. 2B, the transient event 212 includes: an abrupt voltage spike (e.g., a transition from 10.8V to 26V), a jump start interval (e.g., at 26V for 60 seconds), and an abrupt voltage drop (e.g., dropping from 26 back to 10.8V) after the jump start interval.

In the example of FIG. 2C, the transient event 222 of graph 220 is a transient load. During a transient load, brief current pulses (e.g., each pulse having an amplitude of 1A-2A pulses and a duration of 750 ms) are needed by a load (e.g., the load 150 in FIGS. 1A and 1B).

In some examples, transient events (e.g., the transient event 202 of FIG. 2A, the transient event 212 of FIG. 2B, and the transient event 222 of FIG. 2C) during a sleep mode may result in an overcurrent condition at the transistor SLEEP_FET. In some examples, a protection circuit controller (e.g., the controller 110 in FIG. 1A and/or the controller 110A in FIG. 1B) operate to: detect the overcurrent condition; and responsive to the detected overcurrent condition, perform transient event response operations as described herein. Example transient event response operations include: turning off the sleep mode switch (e.g., the transistor SLEEP_FET in FIGS. 1A and 1B); and turning on at least one switch of a switch interface (e.g., the transistor Q2 in FIG. 1B) for a transient interval. After the transient interval, the controller returns to the sleep mode. In some examples, the controller is able to adjust the duration of the transient interval. Transient event response operations can be repeated (e.g., for a transient load event such as the example shown in FIG. 2C).

In some examples, the transient interval duration may be selected based on the expected duration of a particular transient event (e.g., a load dump, a jump start, or a transient load). In other examples, the transient interval duration may be selected based on a shortest expected transient event (e.g., an expected load dump duration). In such examples, longer transient events (e.g., a jump start or a transient load) may result in multiple iterations of overcurrent detection, transient event response operations, and returning to the sleep mode. In other examples, an average or mean transient interval duration for expected transient events may be selected.

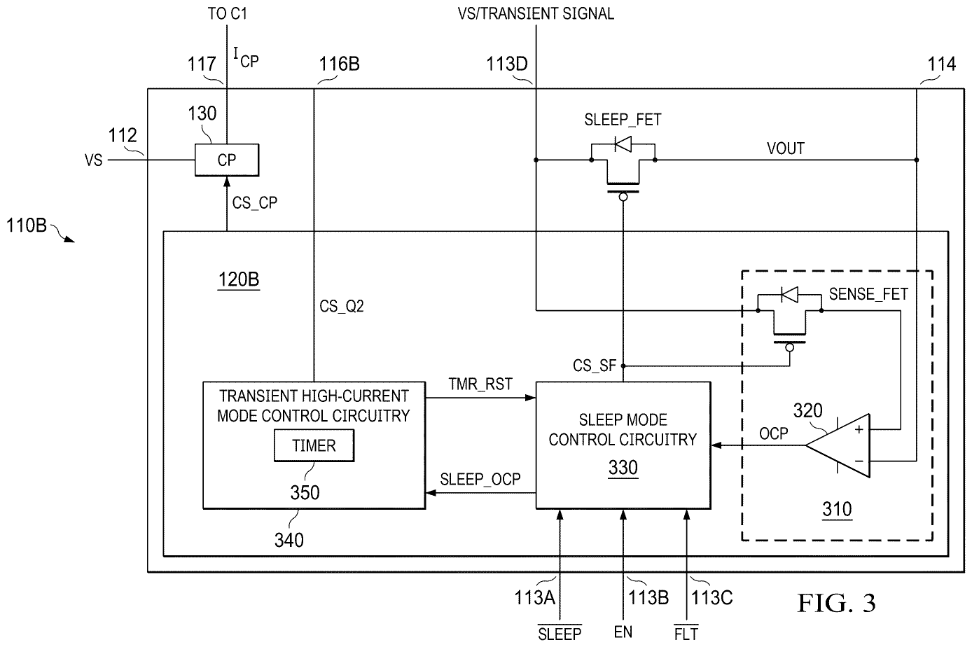

FIG. 3 is a schematic illustrating a diagram of a protection circuit controller 110B, according to various examples. The protection circuit controller 110B is an example of the controller 110 in FIG. 1A, or the controller 110A in FIG. 1B. In some examples, the protection circuit controller 110B is an IC and may be used with an external switch interface (e.g., the switch interface 104 in FIG. 1A, or the switch interface 104A in FIG. 1B). As shown, the protection circuit controller 110B has the first terminal 112, the second terminal 114, the first input 113A, the second input 113B, the third input 113C, the fourth input 113D, the second switch control output 116B, and the charge pump output 117 described in FIG. 1B. In the example of FIG. 3, the protection circuit controller 110B includes the transistor SLEEP_FET, the charge pump circuit 130, and control circuitry 120B in the arrangement shown. The control circuitry 120B is an example of the control circuitry 120 in FIG. 1A, or the control circuitry 120A in FIG. 1B.

In the example of FIG. 3, the control circuitry 120B includes an overcurrent detection circuit 310, sleep mode logic/driver 330, and a transient high-current mode logic/driver 340 in the arrangement shown. In some examples, the overcurrent detection circuit 310 includes a transistor SENSE_FET and a comparator 320. In some examples, the transistor SENSE_FET is a PFET with a first current terminal (e.g., a source terminal), a second current terminal (e.g., a drain terminal), and a control input (e.g., gate terminal).

In the example of FIG. 3, the protection circuit controller 110B (e.g., using control circuitry 120B) supports steady-state mode operations, sleep mode operations, transient high-current mode operations, latch off sleep mode operations, and switching between the different modes as described in FIGS. 1A and 1B. The different modes of the control circuitry 120B may be triggered by: the state of the sleep signal SLEEP at the first input 113A of the protection circuit controller 110B; the state of the enable signal EN at the second input 113B of the protection circuit controller 110B; the state of the fault signal FLT at the third input 113C of the protection circuit controller 110B; and the transient signal at the fourth input 113D of the protection circuit controller 110B. In the example of FIG. 3, the control circuitry 120B may also enable/disable the charge pump circuit 130 as part of selectively driving transistors of a switch interface (e.g., the transistors Q1 and Q2 herein).

During steady-state mode operations, the protection circuit controller 110B (e.g., using the control circuitry 120B) operates to: control the state of CS_Q1 (not shown) to turn on a first transistor (e.g., the transistor Q1); control the state of CS_Q2 at the second switch control output 116B to turn on a second transistor (e.g., the transistor Q2); enable the charge pump circuit 130 to provide I_{CP} at the charge pump output 117 (e.g., to charge the capacitor C1 and power drive signals or a separate driver for external transistors such as the transistors Q1 and Q2); and control the state of CS_SF to turn off the transistor SLEEP_FET. In some examples, the protection circuit controller 110B (e.g., using the control circuitry 120B) initiates the steady-state mode responsive to S̅L̅E̅E̅P̅ having the first state (e.g., a high or “1” state) indicating no sleep request, EN having the first state (e.g., a high or “1” state), and F̅L̅T̅ having the first state (e.g., a high or “1” state).

During sleep mode operations, the protection circuit controller 110B (e.g., using the control circuitry 120B) operates to: control the state of CS_Q1 (not shown) to turn off a first external transistor (e.g., the transistor Q1); control the state of CS_Q2 at the second switch control output 116B to turn off a second external transistor (e.g., the transistor Q2); disable the charge pump circuit 130 to reduce power consumption; and control the state of CS_SF to turn on the transistor SLEEP_FET. In some examples, the protection circuit controller 110B (e.g., using the control circuitry 120B) transitions from the steady-state mode to the sleep mode responsive to S̅L̅E̅E̅P̅ having the second state (e.g., a low or “0” state), EN having the first state (e.g., a high or “1” state), and F̅L̅T̅ having the first state (e.g., a high or “1” state).

During the sleep mode, a transient event may occur. Example transient events include a load dump, a jump start, and a transient load. In the example of FIG. 3, the overcurrent detection circuit 310 detects such transient events as a second overcurrent condition (separate from F̅L̅T̅) related to the transistor SLEEP_FET. In some examples, the control circuitry 120B enables the overcurrent detection circuit 310 during the sleep mode and disables the overcurrent detection circuit 310 during the steady-state mode, the transient high-current mode, and the latch off sleep mode. When enabled, the overcurrent detection circuit 310 compares a scaled voltage due to current through the transistor SENSE_FET with the voltage due to current through the transistor SLEEP_FET. The scaling applied to the SENSE_FET voltage depends on the relative sizes of the transistors SLEEP_FET and SENSE_FET. In some examples, the scaling is 5000 (meaning the transistor SENSE_FET is 5000 times smaller than the transistor SLEEP_FET). In an overcurrent condition, the comparator 320 operates to: detect that the scaled voltage due to current through the transistor SENSE_FET is greater than the voltage due to current through the transistor SLEEP_FET; and, in response, control overcurrent indicator OCP to have a first state (e.g., a high or “1” state) indicating an overcurrent condition at the transistor SLEEP_FET.

In response to OCP indicating an overcurrent condition, the control circuitry 120B transitions to the transient high-current mode. More specifically, in some examples, the sleep mode logic/driver 330 operates to: detect when the overcurrent indicator OCP has a first state; provide control signal SLEEP_OCP with a first state (e.g., a high or “1” state) indicating an overcurrent condition for the transistor SLEEP_FET; and control a state of the switch control signal CS_SF to turn off the transistors SLEEP_FET and SENSE_FET. The transient high-current mode logic/driver 340 receives the control signal SLEEP_OCP. Responsive to the control signal SLEEP_OCP having the first state, the transient high-current mode logic/driver 340 operates to: start the timer 350 to initiate the transient interval; and control the state of CS_Q2 to turn on an external transistor (e.g., the transistor Q2) during the transient interval. Other example transient high-current mode operations include: controlling the state of CS_SF to turn off the transistor SLEEP_FET; and controlling a state of CS_CP to enable the charge pump circuit 130 to provide I_{CP} at the charge pump output 117 for the transient interval. In some examples, the protection circuit controller 110B is able to adjust the duration of the transient interval. For example, the control circuitry 120B may allow for programming the timer 350 to adjust the transient interval duration.

After the transient interval expires, the transient high-current mode logic/driver 340 operates to: control the state of CS_Q2 to turn off the external transistor (e.g., the transistor Q2); and provide control signal TMR_RST with a first state (e.g., a high or “1” state) to indicate the transient interval is complete. The sleep mode logic/driver 330 receives the control signal TMR_RST. Responsive to the control signal SLEEP_OCP having the first state, the sleep mode logic/driver 330 initiates sleep mode operations again (e.g., turning on the transistor SLEEP_FET, enabling the overcurrent detection circuit 310, turning off switches of a switch interface).

In some examples, switching between sleep mode operations and transient high-current mode operations may be repeated as long as FLT has the first state (e.g., a high or “1” state) indicating there is no fault condition for an external switch interface and the sleep mode current is higher than the overcurrent detection threshold for the sleep mode switch. If FLT has a second state (e.g., a low or “0” state) indicating an external switch interface has a fault condition (e.g., the first overcurrent condition), the protection circuit controller 110B (e.g., using the control circuitry 120B) may transition from the transient high-current mode to the latch off sleep mode. In some examples, during the latch off sleep mode, the protection circuit controller 110B operates to: control a state of CS_Q1 (not shown) and CS_Q2 to turn off the transistors Q1 and Q2; control a state of CS_CP to disable the charge pump 130; and control a state of the switch control signal CS_SF to turn off the transistor SLEEP_FET.

In some examples, the controller 110B (e.g., using the control circuitry 120B) may transition from the latch off sleep mode to the steady-state mode responsive to SLEEP having the first state (e.g., a high or “1” state) indicating there is no sleep request. In other examples, the controller 110B (e.g., using the control circuitry 120B) may transition from the latch off sleep mode to the sleep mode responsive to EN transitioning from the first state (e.g., a high or “1” state) to the second state (e.g., a low or “0” state”) and back to the first state. If an overcurrent condition occurs during the sleep mode, the controller 110B can transition from the sleep mode to the transient high-current mode for a transient interval and then return to the sleep mode. In other examples, the controller 110B (e.g., using the control circuitry 120B) may transition from the latch off sleep mode to the sleep mode responsive to VS transitioning from high to low and back to high. If an overcurrent condition occurs at the SLEEP_FET transistor during the sleep mode, the controller 110B can transition from the sleep mode to the transient high-current mode for a transient interval and then return to the sleep mode.

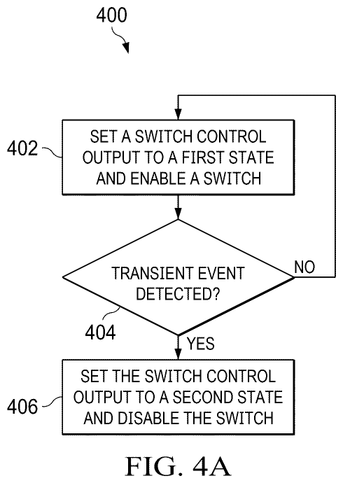

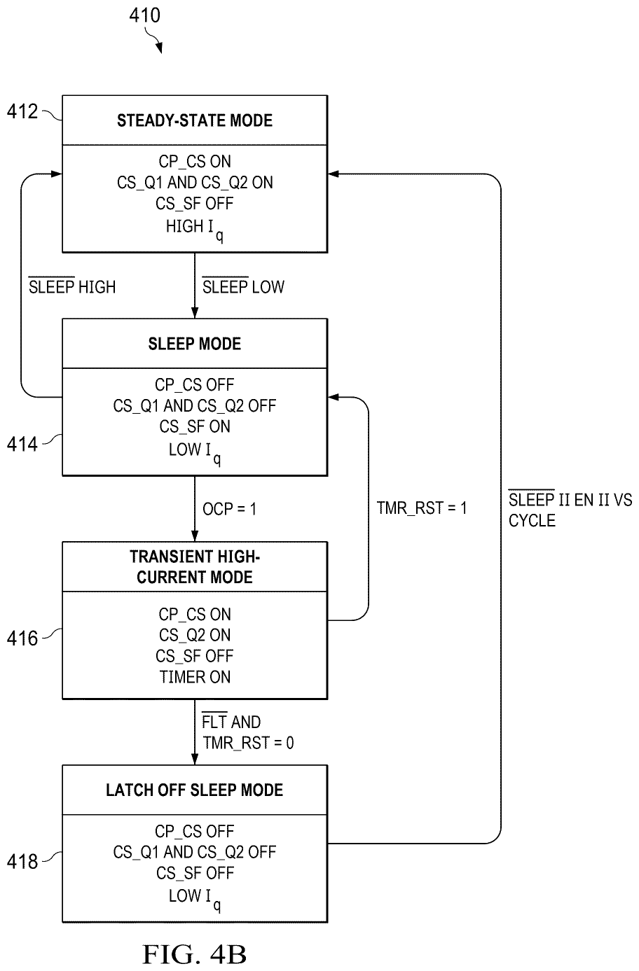

FIG. 4A is a flowchart illustrating a protection circuit controller method 400, according to various examples. The protection circuit controller method 400 may be performed by the controller 110 in FIG. 1A, the controller 110A in FIG. 1B, or the protection circuit controller 110B in FIG. 3. As shown, the protection circuit controller method 400 includes setting a switch control output (e.g., the switch control output(s) 116 in FIG. 1A, the second switch control output 116B in FIGS. 1B and 3) to a first state and enable a switch (e.g., a sleep mode switch such as the transistor SLEEP_FET herein) at block 402. Responsive to a transient event being detected (block 404), the switch control output is set to a second state and the switch is disabled at block 406. In the protection circuit controller method 400, the first state of the switch control output may be an off state for one or more switches (e.g., the transistor Q2 herein) of a switch interface, and the second state of the switch control output may be an on state for one or more switches (e.g., the transistor Q2 herein) of a switch interface.

FIG. 4B is a diagram illustrating a state machine 410 with modes (412, 414, 416, 418) of a protection circuit controller (e.g., the controller 110 in FIG. 1, the controller 110A in FIG. 1B, or the protection circuit controller 110B in FIG. 3), according to various examples. The modes of FIG. 4B are controlled, for example, using control circuitry 120 in FIG. 1A, control circuitry 120A in FIG. 1B, or control circuitry 120B in FIG. 3. As shown, the state machine 410 include a steady-state mode 412 (e.g., a first mode), a sleep mode 414 (e.g., a second mode), a transient high-current mode 416 (e.g., a third mode), and a latch off sleep mode 418 (e.g., a fourth mode).

The steady-state mode 412 (e.g., the first mode) of the state machine 410 is triggered, for example, if S̅L̅E̅E̅P̅ is high, EN is high, VS is available, and F̅L̅T̅ is high. During the steady-state mode 412, CP_CS has an on-state, CS_Q1 and CS_Q2 have an on-state, and CS_SF has an off-state. During the steady-state mode 412, if S̅L̅E̅E̅P̅ becomes low (indicating a sleep mode request), the state machine 410 transitions from the steady-state mode 412 to the sleep mode 414 (e.g., the second mode). During the sleep mode 414, CP_CS has an off-state, CS_Q1 and CS_Q2 have an off-state, and CS_SF has an on-state. During the sleep mode 414, if S̅L̅E̅E̅P̅ becomes high (indicating no sleep mode request), the state machine 410 transitions from the sleep mode 414 to the steady-state mode 412. The state machine 410 can transition between the steady-state mode 412 and the sleep mode 414 based on the state of S̅L̅E̅E̅P̅ until OCP=1 during the sleep mode 414 indicating an overcurrent condition for the sleep mode switch (e.g., the transistor SLEEP_FET herein).

Responsive to OCP=1 during the sleep mode 414, the state machine 410 transitions of the transient high-current mode 416 (e.g., the third mode). During the transient high-current mode 416, CP_CS has an on-state, CS_Q2 has an on-state, CS_SF has an off-state, and a timer (e.g., the timer 350) is turned on. In some examples, CS_Q1 need not be on during the transient high-current mode 416 due to Q1 conducting current in the forward direction (diode behavior). After the timer expires, TMR_RST is high or “1” (indicating the transient interval or related timer has expired), and the state machine 410 transitions from the transient high-current mode to the sleep mode 414. If TMR_RST is low or “0” (indicating the timer has not expired) and FLT is low or “0” (indicating a switch interface fault condition), the state machine 410 transitions from the transient high-current mode 416 to the latch off sleep mode 418. In the latch off sleep mode 418, CP_CS has an off-state, CS_Q1 and CS_Q2 have an off-state, and CS_SF has an off-state. The state machine 410 transitions from the latch off sleep mode 418 depending on the state of S̅L̅E̅E̅P̅, EN, or VS. In some examples, the state machine 410 may transition from the latch off sleep mode to the steady-state mode responsive to S̅L̅E̅E̅P̅ having the first state (e.g., a high or “1” state) indicating there is no sleep request. In other examples, the state machine 410 may transition from the latch off sleep mode to the sleep mode responsive to EN transitioning from the first state (e.g., a high or “1” state) to the second state (e.g., a low or “0” state”) and back to the first state.

If an overcurrent condition occurs at the SLEEP_FET transistor during the sleep mode (OCP=1 as shown in FIG. 4B), the state machine 410 can transition from the sleep mode to the transient high-current mode for a transient interval and then return to the sleep mode after the transient interval expires indicated by a timer (e.g., represented by TMR_RST=1 in FIG. 4B). The state machine 410 may also transition from the latch off sleep mode to the sleep mode responsive to VS transitioning from high to low and back to high, and from the sleep mode, can transition to the transient high-current mode if an overcurrent condition at the SLEEP_FET transistor is detected.

In some examples, if FLT becomes low (indicating a switch interface fault condition, such as an overcurrent condition at transistors Q1 and/or Q2) during steady-state mode 412, the state machine 410 may transition to the latch off sleep mode 418 (e.g., the fourth mode) to disconnect the power source 140 from the load 150.

In some examples, the steady-state mode 412 is a high Iq state (e.g., with Iq of approximately 650 uA) and the sleep mode 414 is a low Iq state (e.g., with Iq of approximately 5 uA. The transient high-current mode 416 may have Iq similar to the steady-state mode 412, and the latch off sleep mode 418 may have Iq even lower than the sleep mode 414.

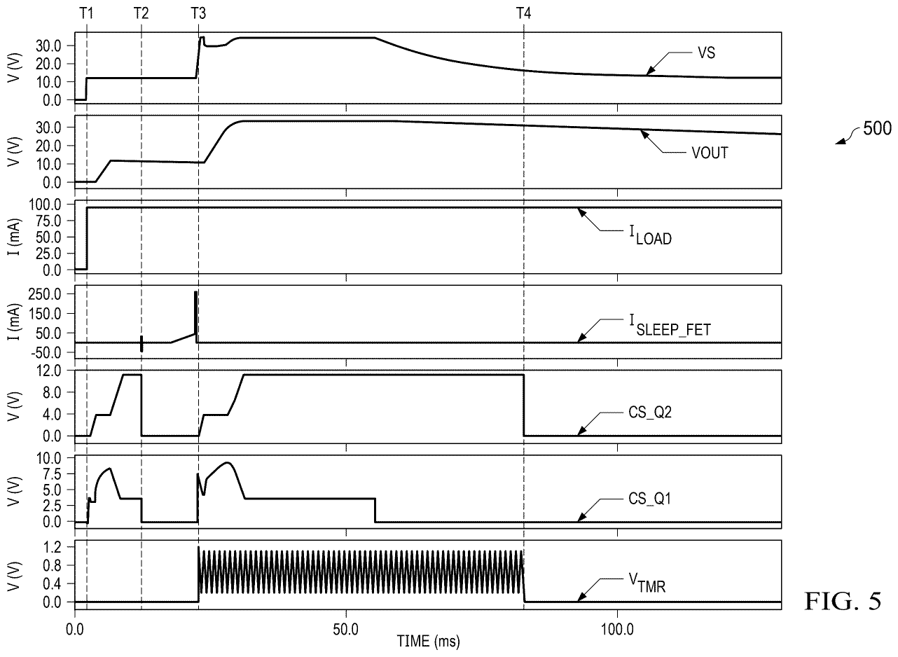

FIGS. 5 to 7 are timing diagrams 500, 600, and 700 showing protection circuit signals responsive to different transient events, according to various examples. As described herein, such transient events may occur during a sleep mode and cause an overcurrent condition for the sleep mode switch (e.g., the transistor SLEEP_FET herein). In the example of FIG. 5, the timing diagram 500 shows protection circuit signals for a load dump scenario. The protection circuit signals represented in FIG. 5 include: VS, VOUT, a load current I_{LOAD}, a sleep mode switch current I_{SLEEP_FET}, CS_Q2, CS_Q1, and a timer voltage V_{TMR}. For the timing diagram 500, the load dump causes VS to increase from 12V to 35V (at time T3) at slew rate of 30V/ms and stay at 35V for 40 ms. For the example of FIG. 5, the value of the capacitor COUT is assumed to be 1 mF, and the load in sleep mode is assumed to 100 mA.

In the load dump scenario of FIG. 5, VS, VOUT, CS_Q2, CS_Q1, and V_{TMR} are initially low due to an off state. At time T1, I_{LOAD} abruptly increases due to a steady-state mode causing VS (due to SLEEP_FET current conduction), VOUT, CS_Q2, and CS_Q1 to increase temporarily from time T1 to T2. At time T2, a sleep mode is initiated, where CS_Q2 and CS_Q1 become low to turn off related switch interface transistors (e.g., the transistors Q1 and Q2 herein). During the sleep mode, I_{SLEEP_FET} may be zero or may be set to target sleep mode current (e.g., 100 mA). At time T3, a load dump causes a step up in VS (e.g., from 12V to 35V at 30V/ms) and an overcurrent condition for I_{SLEEP_FET}. In response to the overcurrent condition being detected (e.g., by the overcurrent detection circuit 310), a timer (e.g., the timer 350) is started and V_{TMR} begins to ramp up and down for a transient interval from time T3 to time T4. During the transient interval, CS_Q1 may vary and the related transistor (e.g., the transistor Q1) will conduct current in the forward direction whether on or off. Meanwhile, during the transient interval, CS_Q2 is controlled so that the related transistor (e.g., the transistor Q2) will conduct in the forward direction. After the transient interval is complete at time T4, CS_Q2 drops and the related transistor (e.g., the transistor Q2) is turned off. After time T4, I_{LOAD} stays high, VS slowly drops back down to 12V, the protection circuit controller may transition to the sleep mode, and the load dump scenario is over.

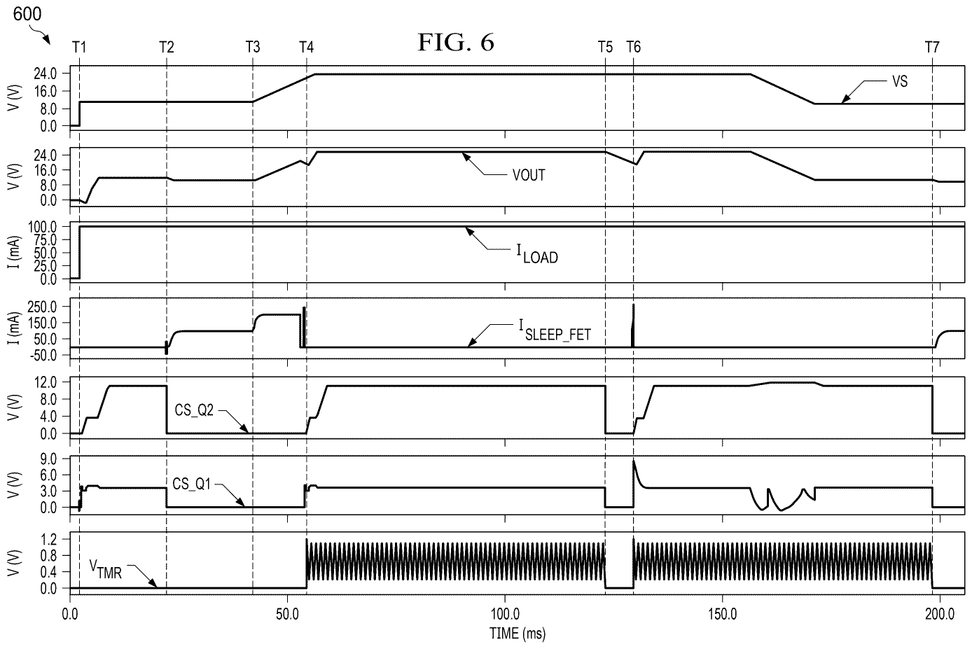

In the example of FIG. 6, the timing diagram 600 shows protection circuit signals for a jump start scenario. The protection circuit signals represented in FIG. 6 include: VS, VOUT, I_{LOAD}, I_{SLEEP_FET}, CS_Q2, CS_Q1, and V_{TMR}. For the timing diagram 600, the jump start causes VS to increase from 12V to 26V (from time T3 to time T4) at slew rate of 1V/ms and stay at 26V for 100 ms. For the example of FIG. 6, the value of the capacitor COUT is assumed to be 100 uF, and the load in sleep mode is assumed to 100 mA.

In the jump start scenario of FIG. 6, VS, VOUT, CS_Q2, CS_Q1, and V_{TMR} are initially low due to an off state. At time T1, I_{LOAD} abruptly increases due to a steady-state mode causing VS (due to SLEEP_FET current conduction), VOUT, CS_Q2, and CS_Q1 to increase temporarily from time T1 to T2. At time T2, a sleep mode is initiated, where CS_Q2 and CS_Q1 become low to turn off related switch interface transistors (e.g., the transistors Q1 and Q2 herein). During the sleep mode, I_{SLEEP_FET} may be zero or may be set to target sleep mode current (e.g., 100 mA). At time T3, a jump start causes a step up in VS (e.g., from 12V to 26V at 1V/ms) and an overcurrent condition for I_{SLEEP_FET} at time T4. In some examples, the overcurrent condition for the jump start scenario is due to a sleep mode clamping operations. In some examples, the sleep mode clamping operations include: detecting that VS goes above a threshold; turning the sleep mode switch on and off using hysteresis to maintain VOUT at the threshold. Due to hysteretic control of the sleep mode switch, an overcurrent condition for the sleep mode switch may occur due to the difference between VS and VOUT. In response to an overcurrent condition for the sleep mode switch being detected (e.g., by the overcurrent detection circuit 310), a timer (e.g., the timer 350) is started and V_{TMR} begins to ramp up and down for a first transient interval from time T4 to time T5. During the first transient interval, CS_Q1 may vary and the related transistor (e.g., the transistor Q1) will conduct current in the forward direction whether on or off. Meanwhile, during the first transient interval, CS_Q2 is controlled so that the related transistor (e.g., the transistor Q2) will conduct in the forward direction. After the first transient interval is complete at time T5, CS_Q2 drops and the related transistor (e.g., the transistor Q2) is turned off. After time T5, VOUT begins to fall (e.g., due to the off state of the sleep mode switch and the off state of switch interface switches) and I_{SLEEP_FET} increases resulting in another overcurrent condition for I_{SLEEP_FET} at time T6. In response to the overcurrent condition being detected (e.g., by the overcurrent detection circuit 310), a timer is started and V_{TMR} begins to ramp up and down again for a second transient interval from time T6 to time T7. During the second transient interval, CS_Q1 may vary and the related transistor (e.g., the transistor Q1) will conduct current in the forward direction whether on or off. Meanwhile, during the second transient interval, CS_Q2 is controlled so that the related transistor (e.g., the transistor Q2) will conduct in the forward direction. By the time the second transient interval is complete at time T7, VS has dropped from 26V to 12V, the protection circuit controller may transition to the sleep mode, and the jump start scenario is over.

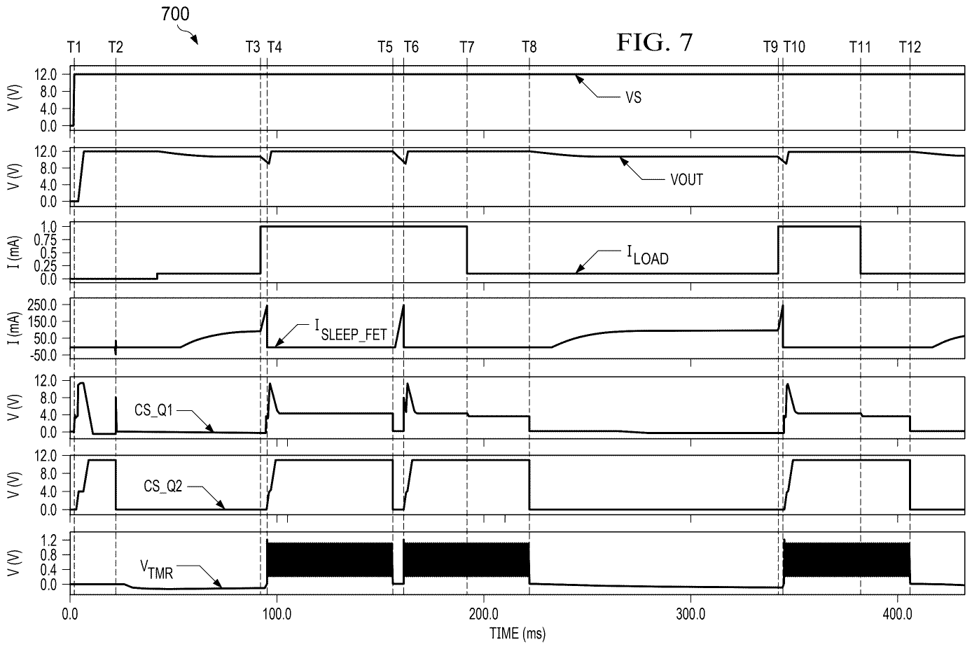

In the example of FIG. 7, the timing diagram 700 shows protection circuit signals for a transient load scenario. The protection circuit signals represented in FIG. 7 include: VS, VOUT, I_{LOAD}, I_{SLEEP_FET}, CS_Q2, CS_Q1, and V_{TMR}. For the timing diagram 700, the transient load includes a first load pulse for I_{LOAD} having a duration 100 ms (e.g., from time T3 to time T8) and a second load pulse for I_{LOAD} having a duration of 40 ms (e.g., from time T9 to time T11). In some examples, the amplitude of each load pulse may be 100 mA to 1A. In the transient load scenario, each load pulse causes an overcurrent condition for I_{SLEEP_FET}. For the example of FIG. 7, VS is assumed to be 12V, the value of the capacitor COUT is assumed to be 2 mF.

In the load transient scenario of FIG. 7, VS, VOUT, CS_Q2, CS_Q1, and V_{TMR} are initially low due to an off state. At time T1, VS, VOUT, CS_Q2, and CS_Q1 increases due to a steady-state mode being initiated. At time T2, a sleep mode is initiated, where CS_Q2 and CS_Q1 become low to turn off related switch interface transistors (e.g., the transistors Q1 and Q2 herein). During the sleep mode, I_{SLEEP_FET} may be zero or may be set to target sleep mode current (e.g., 100 mA). At time T3, the first load pulse causes VOUT to drop and an overcurrent condition for I_{SLEEP_FET} at time T4. In response to the overcurrent condition being detected (e.g., by the overcurrent detection circuit 310), a timer (e.g., the timer 350) is started and V_{TMR} begins to ramp up and down for a first transient interval from time T4 to time T5. During the first transient interval, CS_Q1 may vary and the related transistor (e.g., the transistor Q1) will conduct current in the forward direction whether on or off. Meanwhile, during the first transient interval, CS_Q2 is controlled so that the related transistor (e.g., the transistor Q2) will conduct in the forward direction.

After the first transient interval is complete at time T5, CS_Q2 drops and the related transistor (e.g., the transistor Q2) is turned off. After time T5, VOUT begins to fall again due to first load pulse and I_{SLEEP_FET} again increases resulting in another overcurrent condition for I_{SLEEP_FET} at time T6. In response to the overcurrent condition being detected (e.g., by the overcurrent detection circuit 310), a timer is started and V_{TMR} begins to ramp up and down again for a second transient interval from time T6 to time T8. During the second transient interval, CS_Q1 may vary and the related transistor (e.g., the transistor Q1) will conduct current in the forward direction whether on or off. Meanwhile, during the second transient interval, CS_Q2 is controlled so that the related transistor (e.g., the transistor Q2) will conduct in the forward direction.

Because the first load pulse ends at time T7, VOUT is maintained sufficiently from time T8 to time T9 to avoid an overcurrent condition for the sleep mode switch. At time T9, the second load pulse begins causing VOUT to drop. The drop in VOUT due to the second load pulse causes another overcurrent condition for I_{SLEEP_FET} at time T10. In response to the overcurrent condition being detected (e.g., by the overcurrent detection circuit 310), a timer (e.g., the timer 350) is started and V_{TMR} begins to ramp up and down for a third transient interval from time T10 to time T12. During the third transient interval, CS_Q1 may vary and the related transistor (e.g., the transistor Q1) will conduct current in the forward direction whether on or off. Meanwhile, during the third transient interval, CS_Q2 is controlled so that the related transistor (e.g., the transistor Q2) will conduct in the forward direction. After the third transient interval is complete at time T12, CS_Q2 drops and the related transistor (e.g., the transistor Q2) is turned off. Because the second load pulse ends at time T11, VOUT is maintained sufficiently after time T12 to avoid an overcurrent condition for the sleep mode switch.

Various example embodiments of the disclosure can be described by the following clauses:

Clause 1: An apparatus comprising:
a controller having a switch control output, a first terminal, and a second terminal, the controller including a switch coupled between the first and second terminals, and control circuitry having outputs coupled to the switch control output and a control input of the switch, the control circuitry configurable to:
   in a first mode, set the switch control output to a first state and disable the switch; and
   in a second mode:
      set the switch control output to a second state and enable the switch; and
      responsive to a transient signal at the first terminal or the second terminal, enter a third mode by setting the switch control output to the first state and disabling the switch for an interval, and then transitioning back to the second mode after the interval elapses.

Clause 2. The apparatus of clause 1, wherein the switch is a first switch, the control input is a first control input, and the apparatus comprises a second switch coupled between the first and second terminals, the second switch having a second control input coupled to the switch control output, the second switch being enabled responsive to the switch control output having the first state and disabled responsive to the switch control output having the second state.

Clause 3. The apparatus of any of the preceding clauses, wherein the switch control output is a first switch control output, the controller has a second switch control output and a third terminal, and the apparatus further comprises a third switch coupled between the first and third terminals, the third switch having a third control input coupled to the second switch control output, the controller configurable to enable the third switch during the first mode and disable the third switch during the second mode.

Clause 4. The apparatus of any of the preceding clauses, wherein the first mode is a steady-state mode and the second mode is a sleep mode, and the controller has a sleep mode input and is configurable to enter the steady-state mode or the sleep mode responsive to a state of the sleep mode input.

Clause 5. The apparatus of any of the preceding clauses, wherein the controller is configurable to:
transition to the sleep mode; and
during the sleep mode, enable the first switch, disable the second and third switches, and enable overcurrent detection for the first switch.

Clause 6. The apparatus of any of the preceding clauses, wherein the controller is configurable to:
during the sleep mode, detect an overcurrent condition for the first switch caused by the transient signal;
responsive to detecting the overcurrent condition, disable the first switch, disable the overcurrent detection for the first switch, and enable the second switch for the interval;
return to the sleep mode after the interval has elapsed; and
upon returning to the sleep mode, enable the first switch, enable the overcurrent detection for the first switch, and disable the second switch.

Clause 7. The apparatus of any of the preceding clauses, wherein the controller is configurable to adjust a duration of the interval.

Clause 8. The apparatus of any of the preceding clauses, wherein the controller includes an overcurrent detector coupled between the first and second terminals.

Clause 9. The apparatus of any of the preceding clauses, wherein the overcurrent detector includes a sense transistor and a comparator, the sense transistor coupled between the first terminal and a first input of the comparator, a second input of the comparator coupled to the second terminal.

Clause 10. The apparatus of any of the preceding clauses, wherein the controller is configurable to:
receive an overcurrent indicator from the comparator;
trigger a timer responsive to receiving the overcurrent indicator;
after triggering the timer, disable the overcurrent detection, disable the first switch, and enable the second switch; and
after the timer expires, enable the overcurrent detection, enable the first switch, and disable the second switch.

Clause 11. The apparatus of any of the preceding clauses, wherein the controller is configurable to, in the third mode, responsive to a current between the first and second terminals exceeding a first overcurrent threshold, enter a fourth mode by setting the switch control output to the second state and disabling the switch; and
wherein the controller is configurable to enter the third mode from the second mode responsive to the current exceeding a second overcurrent threshold lower than the first overcurrent threshold.

Clause 12. A method comprising:
in a first mode, disabling a first switch and enabling a second switch to provide a first current path between first and second terminals, and setting a first overcurrent threshold; and
in a second mode:
   enabling the first switch and disabling the second switch to provide a second current path between the first and second terminals, and setting a second overcurrent threshold lower than the first overcurrent threshold; and
   responsive to a transient signal at the first terminal or the second terminal, entering a third mode by enabling the second switch and disabling the first switch for an interval, and then transitioning back to the second mode after the interval elapses.

Clause 13. The method of clause 12, wherein the first mode is a sleep mode, and the second mode is a steady-state mode.

Clause 14. The method of any of the preceding clauses, further comprising entering the sleep mode responsive to receiving a sleep mode signal from a load coupled to the second terminal.

Clause 15. The method of any of the preceding clauses, further comprising:
during the sleep mode, detecting that a current between the first and second terminals exceeding the second overcurrent threshold; and
responsive to detecting that the current exceeds the second overcurrent threshold, disabling the first switch, disabling overcurrent detection for the first switch, and enabling the second switch for a transient interval.

Clause 16. The method of any of the preceding clauses, further comprising:
returning to the sleep mode after the interval; and
upon returning to the sleep mode, enabling the first switch, enabling the overcurrent detection for the first switch, and disabling the second switch.

Clause 17. The method of any of the preceding clauses, further comprising, in the third mode, responsive to a current between the first and second terminals exceeding the first overcurrent threshold, entering a fourth mode by disabling the first and second switches.

Clause 18. A system comprising:
a battery terminal;
a power terminal;
a switch interface between the battery terminal and the power terminal, the switch interface having a control input; and
a controller having a switch control output, a first terminal, and a second terminal, the switch control output coupled to the control input of the switch interface, the controller including a switch coupled between the first and second terminals and configurable to:
   set the switch control output to a first state and enable the switch; and
   responsive to a transient signal at the first terminal or the second terminal, set the switch control output to a second state and disable the switch.

Clause 19. The system of clause 18, wherein the switch is a first switch, the switch interface includes a second switch and a third switch, the system further comprises a battery and a load, the battery is coupled to the battery terminal, the load is coupled to the power terminal, the load is a vehicle load, the switch control output is a first switch control output coupled to a control input of the second switch, the controller has a second switch control output, and the second switch control output is coupled to a control input of the third switch.

Clause 20. The system of any of the preceding clauses, wherein controller is configurable to:
during a steady-state mode, disable the first switch and enable the second and third switches;
transition from the steady-state mode to a sleep mode responsive to a sleep mode signal, in which the controller is configurable to set the switch control output to the first state and enable the first switch in the sleep mode.

Clause 21. The system of any of the preceding clauses, wherein the controller is configurable to:
during the sleep mode, detect an overcurrent condition for the first switch based on the transient signal;
responsive to the detected overcurrent condition, disable the first switch, enable the second and third switches for the interval, and disable the overcurrent detection for the first switch; and
return to the sleep mode after the interval elapses.

Clause 22. The system of any of the preceding clauses, wherein controller is configurable to adjust a duration of the interval.

While various functionalities may be described above independently, it is contemplated that these functionalities may be implemented both independently or in any combination. One of skill in the art will appreciate, in light of the present disclosure, that many combinations of the functionalities described herein are possible.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics, or semiconductor components.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be in depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a controller having a switch control output, a first terminal, and a second terminal, the controller including a switch coupled between the first and second terminals, and control circuitry having outputs coupled to the switch control output and a control input of the switch, the control circuitry configurable to:
in a first mode, set the switch control output to a first state and disable the switch; and
in a second mode:
set the switch control output to a second state and enable the switch; and
responsive to a transient signal at the first terminal or the second terminal, enter a third mode by setting the switch control output to the first state and disabling the switch for an interval, and then transitioning back to the second mode after the interval elapses.

2. The apparatus of claim 1, wherein the switch is a first switch, the control input is a first control input, and the apparatus comprises a second switch coupled between the first and second terminals, the second switch having a second control input coupled to the switch control output, the second switch being enabled responsive to the switch control output having the first state and disabled responsive to the switch control output having the second state.

3. The apparatus of claim 2, wherein the switch control output is a first switch control output, the controller has a second switch control output and a third terminal, and the apparatus further comprises a third switch coupled between the first and third terminals, the third switch having a third control input coupled to the second switch control output, the controller configurable to enable the third switch during the first mode and disable the third switch during the second mode.

4. The apparatus of claim 3, wherein the first mode is a steady-state mode and the second mode is a sleep mode, and the controller has a sleep mode input and is configurable to enter the steady-state mode or the sleep mode responsive to a state of the sleep mode input.

5. The apparatus of claim 4, wherein the controller is configurable to:
transition to the sleep mode; and
during the sleep mode, enable the first switch, disable the second and third switches, and enable overcurrent detection for the first switch.

6. The apparatus of claim 5, wherein the controller is configurable to:
during the sleep mode, detect an overcurrent condition for the first switch caused by the transient signal;
responsive to detecting the overcurrent condition, disable the first switch, disable the overcurrent detection for the first switch, and enable the second switch for the interval;
return to the sleep mode after the interval has elapsed; and
upon returning to the sleep mode, enable the first switch, enable the overcurrent detection for the first switch, and disable the second switch.

7. The apparatus of claim 6, wherein the controller is configurable to adjust a duration of the interval.

8. The apparatus of claim 1, wherein the controller includes an overcurrent detector coupled between the first and second terminals.

9. The apparatus of claim 8, wherein the overcurrent detector includes a sense transistor and a comparator, the sense transistor coupled between the first terminal and a first input of the comparator, a second input of the comparator coupled to the second terminal.

10. The apparatus of claim 9, wherein the controller is configurable to:
receive an overcurrent indicator from the comparator;
trigger a timer responsive to receiving the overcurrent indicator;
after triggering the timer, disable the overcurrent detection, disable the first switch, and enable the second switch; and
after the timer expires, enable the overcurrent detection, enable the first switch, and disable the second switch.

11. The apparatus of claim 1, wherein the controller is configurable to, in the third mode, responsive to a current between the first and second terminals exceeding a first overcurrent threshold, enter a fourth mode by setting the switch control output to the second state and disabling the switch; and
wherein the controller is configurable to enter the third mode from the second mode responsive to the current exceeding a second overcurrent threshold lower than the first overcurrent threshold.

12. A method comprising:
in a first mode, disabling a first switch and enabling a second switch to provide a first current path between first and second terminals, and setting a first overcurrent threshold; and
in a second mode:
enabling the first switch and disabling the second switch to provide a second current path between the first and second terminals, and setting a second overcurrent threshold lower than the first overcurrent threshold; and
responsive to a transient signal at the first terminal or the second terminal, entering a third mode by enabling the second switch and disabling the first switch for an interval, and then transitioning back to the second mode after the interval elapses.

13. The method of claim 12, wherein the first mode is a sleep mode, and the second mode is a steady-state mode.

14. The method of claim 13, further comprising entering the sleep mode responsive to receiving a sleep mode signal from a load coupled to the second terminal.

15. The method of claim 14, further comprising:
during the sleep mode, detecting that a current between the first and second terminals exceeding the second overcurrent threshold; and
responsive to detecting that the current exceeds the second overcurrent threshold, disabling the first switch, disabling overcurrent detection for the first switch, and enabling the second switch for a transient interval.

16. The method of claim 15, further comprising:
returning to the sleep mode after the interval; and
upon returning to the sleep mode, enabling the first switch, enabling the overcurrent detection for the first switch, and disabling the second switch.

17. The method of claim 15, further comprising, in the third mode, responsive to a current between the first and second terminals exceeding the first overcurrent threshold, entering a fourth mode by disabling the first and second switches.

18. A system comprising:
a battery terminal;
a power terminal;
a switch interface between the battery terminal and the power terminal, the switch interface having a control input; and
a controller having a switch control output, a first terminal, and a second terminal, the switch control output coupled to the control input of the switch interface, the controller including a switch coupled between the first and second terminals and configurable to:
set the switch control output to a first state and enable the switch; and
responsive to a transient signal at the first terminal or the second terminal, set the switch control output to a second state and disable the switch.

19. The system of claim 18, wherein the switch is a first switch, the switch interface includes a second switch and a third switch, the system further comprises a battery and a load, the battery is coupled to the battery terminal, the load is coupled to the power terminal, the load is a vehicle load, the switch control output is a first switch control output coupled to a control input of the second switch, the controller has a second switch control output, and the second switch control output is coupled to a control input of the third switch.

20. The system of claim 19, wherein controller is configurable to:
during a steady-state mode, disable the first switch and enable the second and third switches;
transition from the steady-state mode to a sleep mode responsive to a sleep mode signal, in which the controller is configurable to set the switch control output to the first state and enable the first switch in the sleep mode.

21. The system of claim 20, wherein the controller is configurable to:
during the sleep mode, detect an overcurrent condition for the first switch based on the transient signal;
responsive to the detected overcurrent condition, disable the first switch, enable the second and third switches for the interval, and disable the overcurrent detection for the first switch; and
return to the sleep mode after the interval elapses.

22. The system of claim 21, wherein controller is configurable to adjust a duration of the interval.
